(19) United States
(12) Patent Application Publication
(10) Pub. No.: US 2017/0197719 A1
(43) Pub. Date: Jul. 13, 2017

(54) UNMANNED AERIAL VEHICLE FOR EVACUATING PEOPLE FROM SKYSCRAPER AND MANAGING METHOD FOR THE SAME

(71) Applicant: AJOU UNIVERSITY INDUSTRY-ACADEMIC COOPERATION FOUNDATION, Suwon-si (KR)

(72) Inventors: Yong Jin KWON, Suwon-si (KR); Eung Hyun LEE, Yongin-si (KR)

(73) Assignee: AJOU UNIVERSITY INDUSTRY-ACADEMIC COOPERATION FOUNDATION, Suwon-si (KR)

(21) Appl. No.: 15/404,500

(22) Filed: Jan. 12, 2017

(30) Foreign Application Priority Data
Jan. 12, 2016 (KR) 10-2016-0003815

(51) Int. Cl. B64D 9/00; B64C 29/00; B64D 27/24; B64F 1/12; B64C 15/02; B64C 39/02; B64D 47/08

(52) U.S. Cl. CPC B64D 9/00; B64C 39/024; B64C 29/0025; B64D 47/08; B64F 1/12; B64C 15/02; B64D 27/24

(57) ABSTRACT

Provided is an unmanned aerial vehicle for evacuating people from a skyscraper, including: an aerial body unit including an evacuating cage in which a boarding space for evacuating people is formed; a main thrust unit having a form in which a propeller is coupled in a cylindrical structure and installed on both sides of the aerial body unit to take off and raise the aerial body unit by main thrust generated by the propeller; an auxiliary thrust unit having the form in which the propeller is coupled in the cylindrical structure and installed on a rear surface of the aerial body unit and horizontally moving the aerial body unit by auxiliary thrust generated in a vertical direction to an outer wall of the building by the propeller to approach the aerial body unit to the outer wall of the building; and a vacuum adsorption unit installed on a front surface of the aerial body unit and detachably fixed to the outer wall of the building through vacuum adsorption.

### CROSS-REFERENCE TO RELATED APPLICATIONS

This application claims the priority of Korean Patent Application No. 2016-0003815 filed on Jan. 12, 2016, in the Korean Intellectual Property Office, the disclosure of which is incorporated herein by reference.

### BACKGROUND

Field

The present disclosure relates to an unmanned aerial vehicle for evacuating people from skyscrapers and a managing method for the same.

Description of the Related Art

With the development of a modern society, buildings in which human resides or lives have gotten higher day by day. These high-rise buildings have the advantage of efficiently being able to utilize a territory, but how to protect people from disasters such as fire, earthquake, and the like comes to the fore as a serious issue.

Especially, in the case of the fire, when the building goes over more than 15 stories, the fire may not be suppressed by a high-level fire engine, and as a result, it is also difficult to rescue people trapped inside the building. Accordingly, fire helicopters for fire suppression and lifesaving are additionally input, but there is a problem that it is difficult to always operate the fire helicopter in accordance with the time of fire, weather conditions, etc. and there are limits including fire spread depending on a descent wind by a helicopter rotor, high operation cost, low lifesaving efficiency, and the like. In addition, since the life may not be rescued by direct contact with the high-rise building wall due to a structure of the helicopter itself, it is difficult to actively utilize the helicopter.

Currently, countries around the world are developing various robots for the fire suppression and lifesaving. Most of the robots for suppressing the fire are developed in respective countries including Japan, China, USA, etc. instead of directly entering a fire scene by fire fighting personnel in the related art and evolved to a type of recognizing a fire point by using various sensors as well as a remote control, and the like. In addition, efficiency is improved by developing robots that match a fire situation according to an occurrence location of the fire.

Meanwhile, the lifesaving robots are growing at an average annual rate of 11% due to the growth of a global robot market and developed countries invest heavily in the development of the lifesaving robots to efficiently cope with various disasters. Japan has released a life-saving robot that combines humanoid robots with the lifesaving. However, the existing ground-based lifesaving robots may be efficiently used for low-rise buildings or underground fires, but have limitations in that it is difficult to effectively save lives in the high-rise buildings.

As related prior art, Korean Patent Registration No. 10-1566341 (Title invention: A MULTI-PURPOSE FIRE FIGHTING DRONE, Registration date: Oct. 30, 2015).

### SUMMARY

An object to be achieved by the present disclosure is to provide an unmanned aerial vehicle for evacuating people from skyscrapers and a managing method for the same capable of efficiently evacuating people during skyscraper fires.

The objects of the present disclosure are not limited to the aforementioned objects, and other objects, which are not mentioned above, will be apparent to a person having ordinary skill in the art from the following description.

According to an aspect of the present disclosure, there is provided an unmanned aerial vehicle for evacuating people from skyscrapers. The unmanned aerial vehicle includes: an aerial body unit including an evacuating cage in which a boarding space for evacuating people is formed; a main thrust unit having a form in which a propeller is coupled in a cylindrical structure and installed on both sides of the aerial body unit to take off and raise the aerial body unit by main thrust generated by the propeller; an auxiliary thrust unit having the form in which the propeller is coupled in the cylindrical structure and installed on a rear surface of the aerial body unit and horizontally moving the aerial body unit by auxiliary thrust generated in a vertical direction to an outer wall of the building by the propeller to approach the aerial body unit to the outer wall of the building; and a vacuum adsorption unit installed on a front surface of the aerial body unit and detachably fixed to the outer wall of the building through vacuum adsorption.

The main thrust unit may be constituted by at least a pair on two sides of the aerial body unit, in which each pair of propellers rotates clockwise and counterclockwise and control freedom degrees of the aerial body unit by a rotation operation for each pair of propellers.

The unmanned aerial vehicle may further include an aerial control unit detecting a distance between the aerial body unit and the outer wall of the building by using an ultrasonic sensor, determining that the aerial body unit approaches the outer wall of the building when the detected distance is included in a predetermined range, and controlling an operation of the vacuum adsorption unit according to the determined result.

The aerial control unit may detect the building window frame by tracking an outline of the building window frame by using a camera when the aerial body unit approaches the outer wall of the building and control the operation of the main thrust unit and the auxiliary thrust unit to approach the aerial body unit to the building window frame and then control the operation of the vacuum adsorption unit to attach the aerial body unit to the outer wall of the building surrounding the building window frame.

The aerial control unit may control the operation of the main thrust unit to fly the aerial body unit in place in the air when the aerial body unit reaches the corresponding altitude of the building, control the operation of the auxiliary thrust unit to approach the aerial body unit to the outer wall of the building until a distance between the aerial body unit and the outer wall of the building is included in a predetermined range.

The main thrust unit may allow each pair of propellers rotating clockwise and counterclockwise to produce the same output and the sum of yaw becomes 0, and maintains a balance of the aerial body unit to fly the aerial body unit in the air, according to the control of the aerial control unit.

The aerial control unit may activate an approach mode when the aerial body unit approaches the outer wall of the building and reduce controllability according to a console input of the operator to prevent the aerial body unit from being sensitively operated.

The unmanned aerial vehicle may further include an altitude information database unit making into a database and storing altitude information for each layer with respect to a plurality of buildings; and an aerial control unit controlling the operation of the main thrust unit so that the unmanned aerial vehicle is automatically positioned on the corresponding layer of the building by searching the altitude information for the corresponding layer from the altitude information database when information on the corresponding layer of the building for evacuating people is input.

The unmanned aerial vehicle may further include a power supply unit supplying power to the main thrust unit and the auxiliary thrust unit, in which the power supply unit may include a rechargeable battery.

The unmanned aerial vehicle may further include an aerial control unit interrupting the power supplied to the main thrust unit and the auxiliary thrust unit until the boarding of the evacuated people in the evacuating cage is completed when the aerial body unit is attached to the outer wall of the building through the vacuum adsorption of the vacuum adsorption unit to stop an operation of a motor which drives the propellers of the main thrust unit and the auxiliary thrust unit.

The aerial body unit may further include an air curtain installed in a boarding entrance of the evacuating cage, and an air curtain operator which operates the air curtain installed in a boarding entrance of the evacuating cage for safety of the evacuated person when the boarding of the evacuated person in the evacuating cage is completed.

The aerial body unit may further include folding stairs installed on a front side of the evacuating cage for easy boarding of evacuated people which board the evacuating cage.

According to an aspect of the present disclosure, there is provided a managing method for an unmanned aerial vehicle for evacuating people from skyscrapers. The managing method includes: taking off and raising an aerial body unit by main thrust generated by a propeller by controlling an operation of a main thrust unit installed on both sides of the aerial body unit and having a form in which a propeller is coupled in a cylindrical structure; horizontally moving the aerial body unit by auxiliary thrust generated in a vertical direction to an outer wall of the building by the propeller to approach the aerial body unit to an outer wall of a building by controlling the operation of an auxiliary thrust unit installed on a rear surface of the aerial body unit and having the form in which the propeller is coupled in the cylindrical structure; and attaching the aerial body unit to the outer wall of the building through vacuum adsorption of a vacuum adsorption unit by providing vacuum pressure to the vacuum adsorption unit installed on a front surface of the aerial body unit.

The managing method may further include controlling freedom degrees of the aerial body unit by performing a rotation operation for each pair of propellers of the main thrust unit constituted by at least a pair on two sides of the aerial body unit clockwise and counterclockwise, after the taking off and raising the aerial body unit.

The managing method may further include detecting a distance between the aerial body unit and the outer wall of the building by using an ultrasonic sensor; and determining that the aerial body unit approaches the outer wall of the building when the detected distance is included in a predetermined range, after the approaching of the aerial body unit to the outer wall of the building.

The approaching of the aerial body unit to the outer wall of the building may include detecting the building window frame by tracking an outline of the building window frame by using a camera when the aerial body unit approaches the outer wall of the building, and controlling the operation of the main thrust unit and the auxiliary thrust unit to approach the aerial body unit to the building window frame, and the attaching of the aerial body unit to the outer wall of the building may include controlling the operation of the vacuum adsorption unit to attach the aerial body unit to the outer wall of the building surrounding the building window frame.

The managing method may further include controlling the operation of the main thrust unit to fly the aerial body unit in place in the air when the aerial body unit reaches the corresponding altitude of the building after the taking off and raising of the aerial body unit, in which the attaching of the aerial body unit to the outer wall of the building may include controlling the operation of the auxiliary thrust unit to approach the aerial body unit to the outer wall of the building until a distance between the aerial body unit and the outer wall of the building is included in a predetermined range.

The flying of the aerial body unit in place in the air may include allowing, by the main thrust unit, each pair of propellers rotating clockwise and counterclockwise to produce the same output and the sum of yaw becomes 0 and maintains a balance of the aerial body unit to fly the aerial body unit in the air, according to the control of the aerial control unit.

The approaching of the aerial body unit to the outer wall of the building may include activating an approach mode when the aerial body unit approaches the outer wall of the building, and reducing controllability according to a console input of the operator to prevent the aerial body unit from being sensitively operated.

The managing method may further include making altitude information for each layer into a database with respect to a plurality of buildings and storing the altitude information in an altitude information database unit; and controlling the operation of the main thrust unit so that the unmanned aerial vehicle is automatically positioned on the corresponding layer of the building by searching the altitude information for the corresponding layer from the altitude information database when information on the corresponding layer of the building for evacuating people is input.

The managing method may further include interrupting the power supplied to the main thrust unit and the auxiliary thrust unit until the boarding of the evacuated people in the evacuating cage provided in the aerial body unit is completed when the aerial body unit is attached to the outer wall of the building through the vacuum adsorption of the vacuum adsorption unit to stop an operation of a motor which drives the propellers of the main thrust unit and the auxiliary thrust unit.

The managing method may further include operating the air curtain installed in a boarding entrance of the evacuating cage for safety of the evacuated person when the boarding of the evacuated person in the evacuating cage is completed, after the stopping of the operation of the motor.

Details of other exemplary embodiments will be included in the detailed description of the invention and the accompanying drawings.

According to the exemplary embodiment of the present disclosure, the unmanned aerial vehicle can reach a middle layer which is not reached in the related art during the skyscraper fire to enhance efficiency and success rate of life saving, and the size of the aerial vehicle is small, a space required for flying is much smaller than a firefighting helicopter, and a rapid maneuver is possible, thereby efficiently evacuating people.

The effects of the present disclosure are not limited to the aforementioned effects, and various other effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrated for describing an unmanned aerial vehicle for evacuating people from a skyscraper according to an exemplary embodiment of the present disclosure;

FIGS. 2 to 4 are diagrams illustrating an evacuating cage of FIG. 1 in detail;

FIG. 5 is a diagram illustrating an EDF rotation direction of an unmanned aerial vehicle and an axis of the aerial vehicle in an exemplary embodiment of the present disclosure;

FIGS. 6 to 11 are diagrams illustrated for describing position changes of the unmanned aerial vehicle according to driving force of EDF in the exemplary embodiment of the present disclosure;

FIGS. 12 to 14 are used state diagrams illustrating a process of attaching the unmanned aerial vehicle onto an external wall of the building in the exemplary embodiment of the present disclosure;

FIG. 15 is an exemplary diagram illustrating an example of ground control system of controlling the unmanned aerial vehicle for evacuating people from the skyscraper according to the exemplary embodiment of the present disclosure; and

FIG. 16 is a flowchart illustrated for describing a managing method for the unmanned aerial vehicle for evacuating people from the skyscraper according to an exemplary embodiment of the present disclosure.

### DETAILED DESCRIPTION OF THE PREFERRED EMBODIMENT

Advantages and features of the present disclosure, and methods for accomplishing the same will be more clearly understood from exemplary embodiments described below with reference to the accompanying drawings. However, the present disclosure is not limited to the following exemplary embodiments but may be implemented in various different forms. The exemplary embodiments are provided only to complete disclosure of the present disclosure and to fully provide a person having ordinary skill in the art to which the present disclosure pertains with the category of the disclosure, and the present disclosure will be defined by the appended claims. Throughout the whole specification, the same reference numerals denote the same elements.

Hereinafter, exemplary embodiments of the present disclosure will be described in detail with reference to the accompanying drawings.

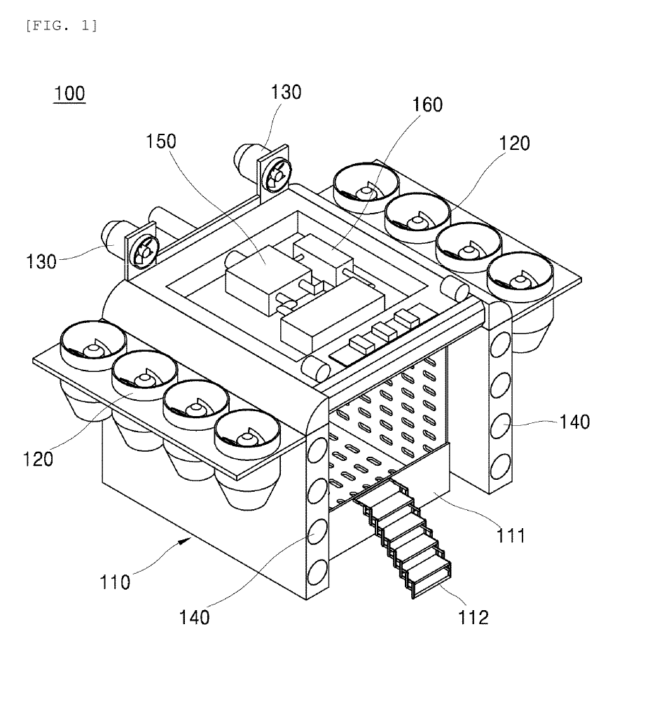

FIG. 1 is a perspective view illustrated for describing an unmanned aerial vehicle for evacuating people from a skyscraper according to an exemplary embodiment of the present disclosure.

Referring to FIG. 1, an unmanned aerial vehicle 100 for evacuating people from a skyscraper according to an exemplary embodiment of the present disclosure may include an aerial body unit 110, a main thrust unit 120, an auxiliary thrust unit 130, a vacuum adsorption unit 140, an aerial control unit 150, and a power supply unit 160.

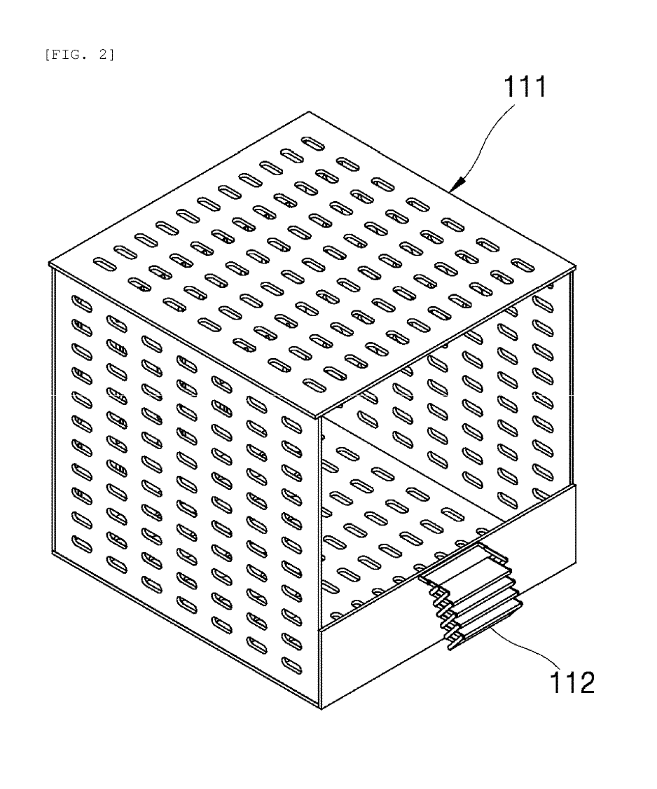

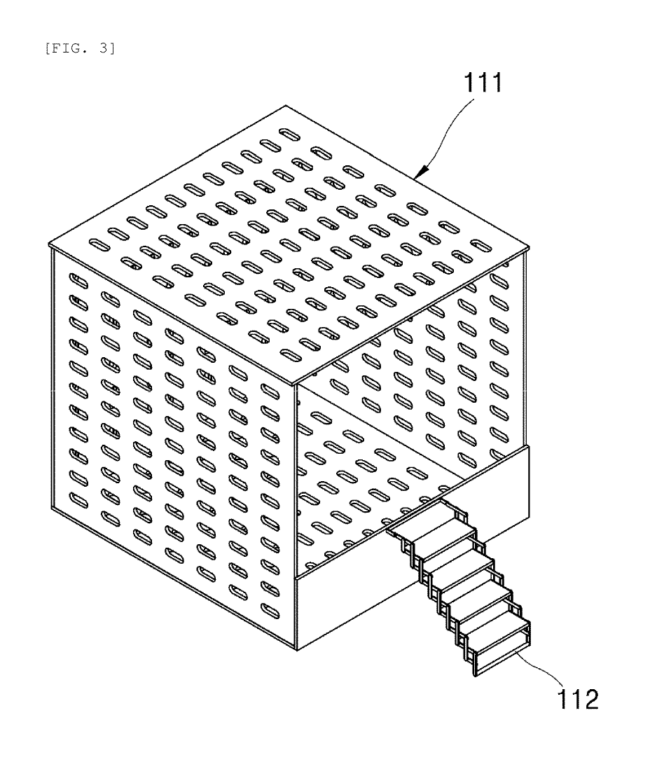

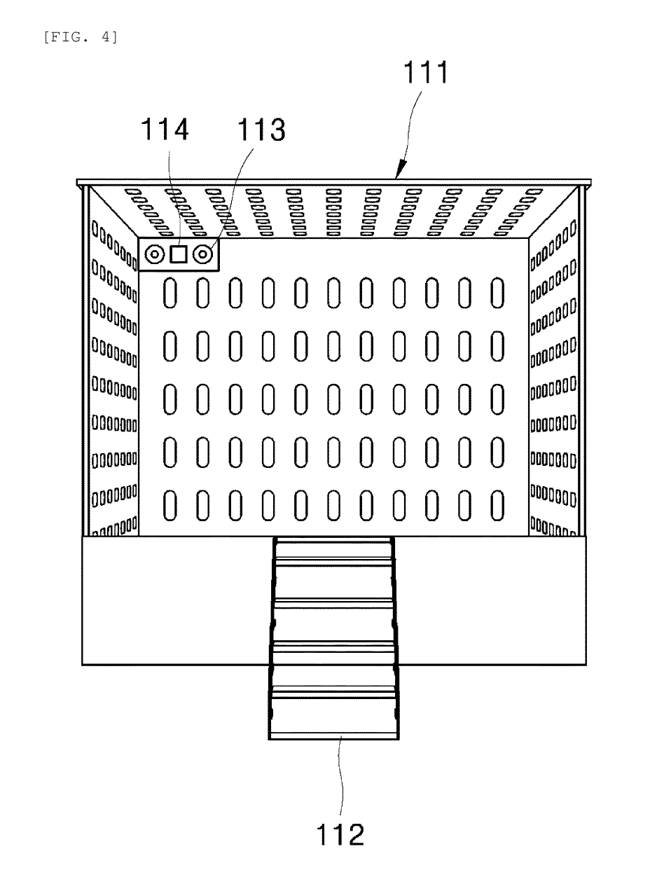

The aerial body unit 110 is a main body configuring the unmanned aerial vehicle 100 for evacuating people from the skyscraper and may include an evacuating cage 111 in which a boarding space for evacuating is formed. In the exemplary embodiment, the evacuating cage 111 is designed as illustrated in FIGS. 2 to 4.

Particularly, referring to FIGS. 2 to 4, the evacuating cage 111 is made of aluminum to promote lightness and has a lot of holes to enhance stiffness and allow an evacuated person to recognize an external situation. For easy boarding of evacuated persons, folding stairs 112 are attached to a front side of the evacuating cage 111 and allow the evacuated person to directly unfold and use the stairs if necessary.

Further, a voice transceiver 113 and a state display lamp 114 are installed in the evacuating cage 111 to allow the evacuated person to communicate directly with the ground control person by voice. Further, a rail (not illustrated) is installed on the evacuating cage 111 and designed to be detached from the aerial body unit 110. This may enhance flexibility in the use of the unmanned aerial vehicle by installing structures having other purposes.

Although not illustrated, the aerial body unit 110 may further include an air curtain installed in a boarding entrance of the evacuating cage 111 and an air curtain operator which operates the air curtain for safety of the evacuated person when the boarding of the evacuated person in the evacuating cage 111 is completed.

The main thrust unit 120 has a form in which a propeller is coupled in a cylindrical structure. In the exemplary embodiment, the main thrust unit 120 may be implemented by an electric ducted fan (EDF). The EDF maximally suppresses a loss of thrust generated by the propeller to efficiently fly the unmanned aerial vehicle. Accordingly, in the EDF, efficiency is higher than a general propellant having a propeller form and thus a size of the propellant itself may be decreased. Noise is also low and a rotation part has a cylindrically covered shape to be safe. The characteristics of the small-size and the low-noise are very suitable to design the unmanned aerial vehicle to fly a space between narrow buildings of the city during the fire and thus as described below, the unmanned aerial vehicle may be attached to the outer wall of the building after approaching.

The main thrust unit 120 is installed on two sides of the aerial body unit 110 to take off and raise the aerial body unit 110 by main thrust generated by the propeller. To this end, the main thrust unit 120 may be constituted by at least a pair on two sides of the aerial body unit 110. In the exemplary embodiment, the main thrust unit 120 may be installed by at four, that is, two pairs on two sides of the aerial body unit 110. In other words, 8 EDFs may be installed by four on the two sides of the aerial body unit 110.

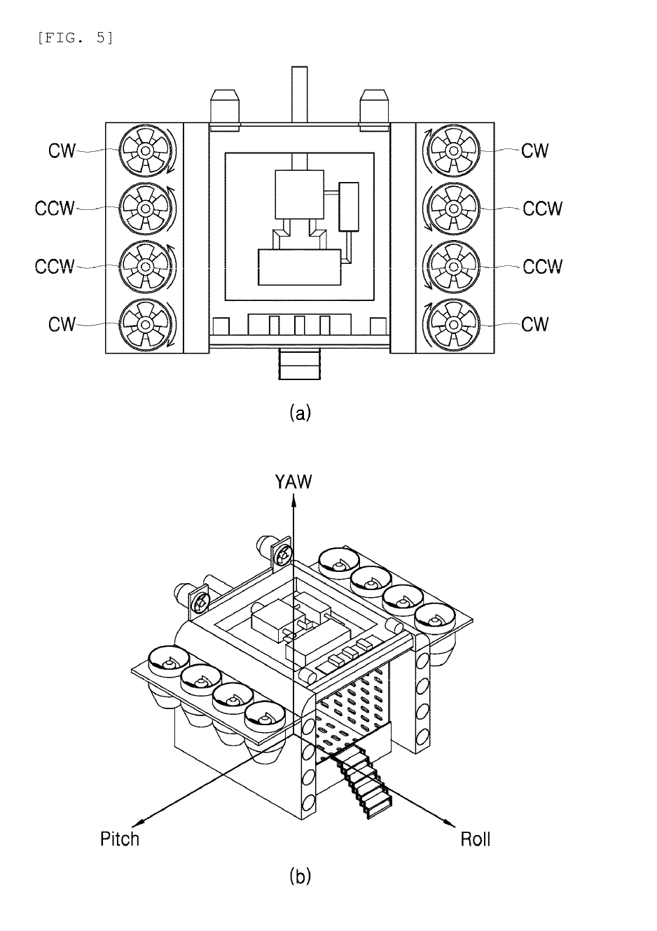

In this case, each pair of propellers may rotate clockwise (CW) and counterclockwise (CCW) as illustrated in FIG. 5. As a result, the main thrust unit 120 offsets torque while ensuring the thrust like each pair of propellers to prevent the aerial body unit 110 from rotating.

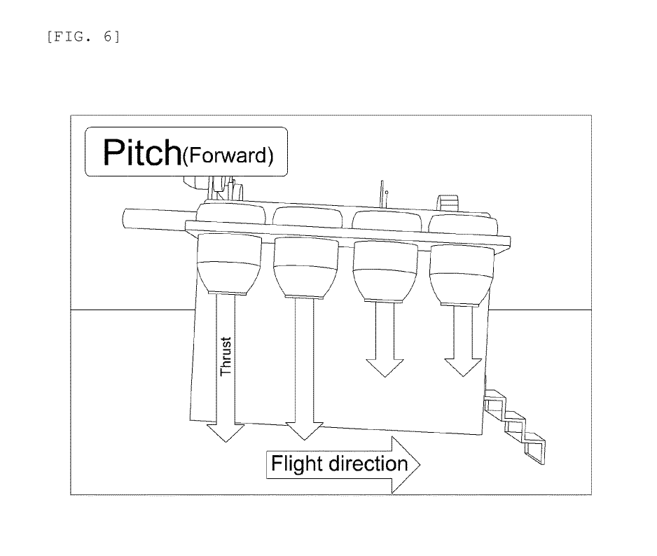

The main thrust unit 120 may control freedom degrees Yaw, Pitch, and Roll of the aerial body unit 110 by a rotation operation for each pair of propeller. Aerial control through control of the freedom degrees of the main thrust unit 120 will be described in detail with reference to FIGS. 6 to 11.

FIGS. 6 to 11 are diagrams illustrating that each EDF as an example of the main thrust unit is operated for aerial control of the unmanned aerial vehicle for evacuating people from the skyscraper according to the exemplary embodiment of the present disclosure. The EDF controls a position and motion of the aerial body unit 110 by adjusting a relative speed for each rotor.

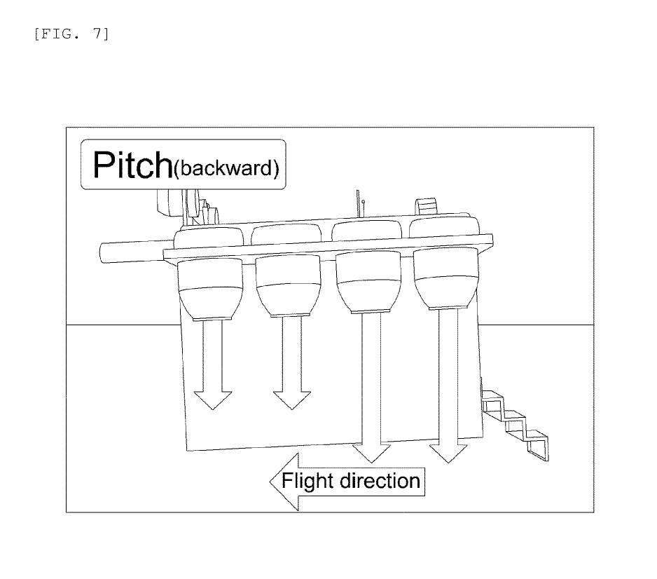

Pitch means rotation of the aerial body unit 110 in a vertical axis to an axis passing through a gravity center of the aerial body unit 110. Accordingly, as illustrated in FIGS. 6 and 7, when thrust of four rear EDFs is controlled to be relatively larger than that of four front EDFs, the gravity center of the aerial body unit 110 moves forward and thus the unmanned aerial vehicle advances and in the case of the opposite control, the unmanned aerial vehicle is reversed.

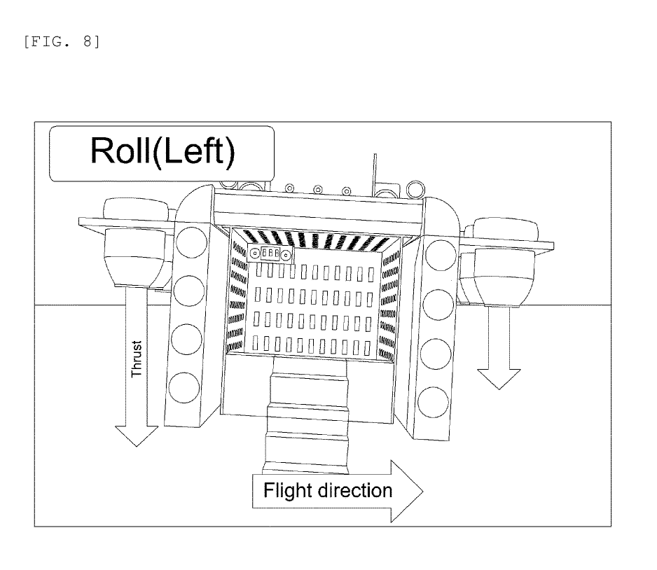

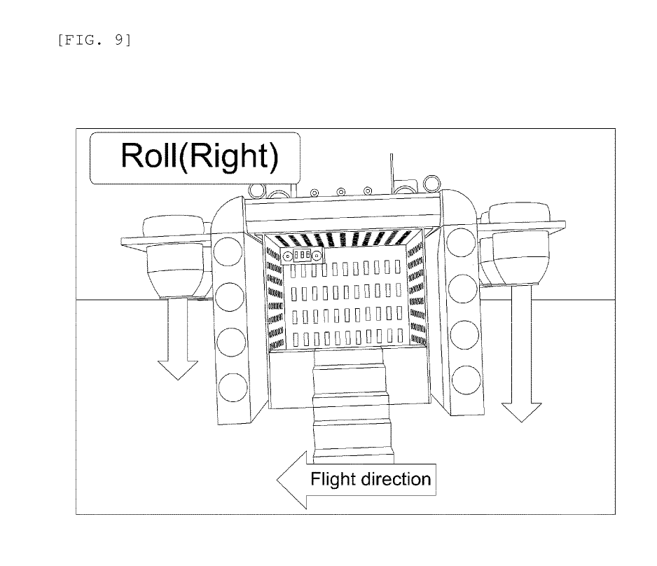

Roll means rotation of the aerial body unit 110 for an axis which is parallel with a progression direction of the aerial body unit 110 and passes through the gravity center of the aerial body unit 110. As illustrated in FIGS. 8 and 9, when thrust of four right EDFs is controlled to be relatively larger than that of four left EDFs, the gravity center of the aerial body unit 110 moves left and thus the unmanned aerial vehicle flies left and in the case of the opposite control, the unmanned aerial vehicle flies right.

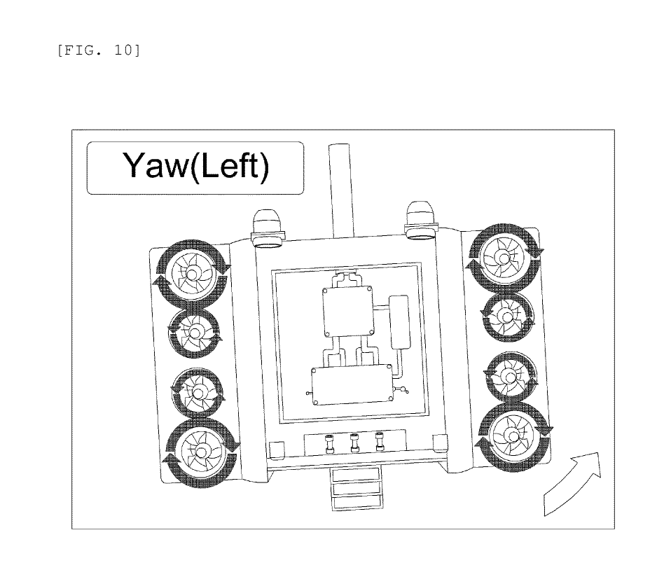

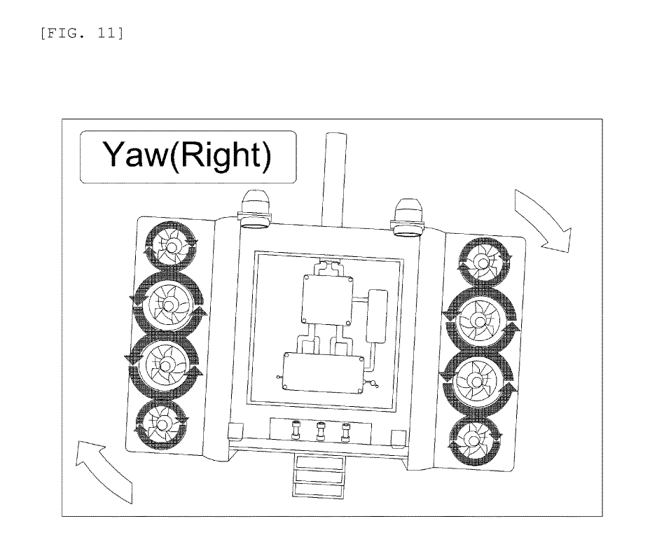

Yaw means rotation for an axis which passes through the aerial vehicle in a vertical direction. As illustrated in FIGS. 10 and 11, Yaw controls the output of two pairs of rotors having opposite directions of rotation to be different. If two pairs of EDFs produce the same output, a resultant force of Yaw becomes 0 and the aerial body unit 110 may maintain a balance. In other words, the main thrust unit 120 allows each pair of propellers rotating clockwise and counterclockwise to produce the same output and the sum of yaw becomes 0 and maintains a balance of the aerial body unit 110 to fly the aerial body unit 110 in place in the air.

The auxiliary thrust unit 130 has a form in which a propeller is coupled in a cylindrical structure. In the exemplary embodiment, the auxiliary thrust unit 130 may be implemented by EDFs like the main thrust unit 120. The auxiliary thrust unit 130 is installed on the rear surface of the aerial body unit 110 and horizontally moves the aerial body unit 110 to approach the outer wall of the building by auxiliary thrust generated in a vertical direction to the outer wall of the building by the propeller.

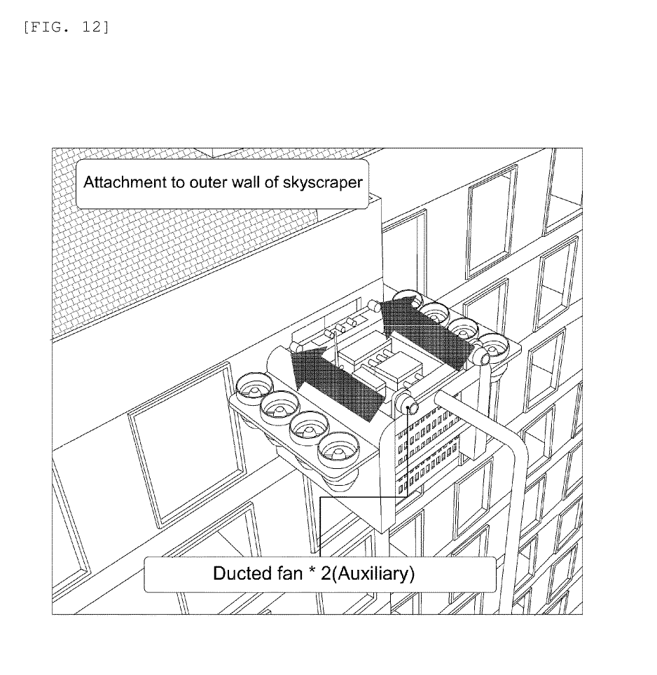

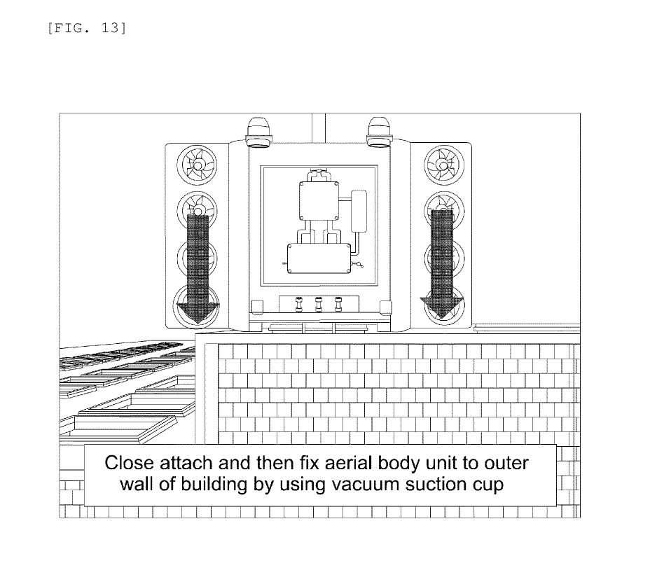

The vacuum adsorption unit 140 is installed on the front surface of the aerial body unit 110 to be detachably fixed to the outer wall of the building through vacuum adsorption. The vacuum adsorption unit 140 may be implemented by a suction cup and may be contacted and fixed to the outer wall of the building by using the suction cup as illustrated in FIGS. 12 and 13.

That is, the vacuum adsorption unit 140 may be attached to the outer wall of the building by receiving vacuum pressure from a vacuum pump (not illustrated) and may be detached from the outer wall of the building by interrupting the vacuum pressure from the vacuum pump. The vacuum pump may be installed on the aerial body unit 110 and alternatively, may be separately installed outside to be provided to the vacuum adsorption unit 140 through a vacuum pipe.

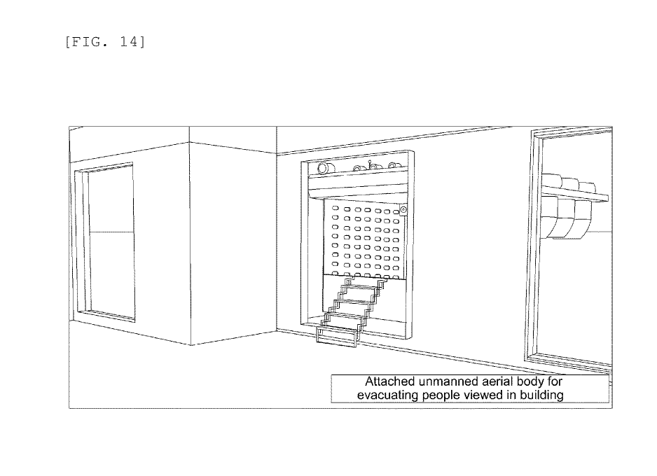

When the aerial body unit 110 is attached to the outer wall of the building by the vacuum adsorption unit 140, as illustrated in FIG. 14, the evacuated person may be board on the evacuating cage 111 through the folding stairs 112.

The unmanned aerial vehicle 100 for evacuating people from the skyscraper is invented to evacuate people through a window of the outer wall of the building for evacuating people during the fire. In the related art, in order to board stably the evacuated person on the unmanned aerial vehicle, the aerial vehicle hovers by maximally approaching the outer wall. However, in the case of the skyscraper, due to external parameters such as building wind flowing strongly between the buildings and shaking of the aerial vehicle due to a change in gravity center on boarding and internal parameters such as malfunction possibility of a sensor of the unmanned aerial vehicle itself, it is difficult to exactly maintain the position.

Accordingly, in the exemplary embodiment of the present disclosure, the unmanned aerial vehicle is attached to the outer wall of the building by strong suction force after approaching a window frame of the outer wall of the building by using the suction cup and a vacuum control unit. In this case, when the unmanned aerial vehicle approaches the outer wall of the building by moving the gravity center using the main thrust EDF, it is difficult to approach the unmanned aerial vehicle to an exact position because the aerial vehicle is inclined. Accordingly, in the exemplary embodiment of the present disclosure, as described above, the aerial vehicle flies in place in the air by using the main thrust EDF and may stably approach the outer wall of the building by using the auxiliary thrust EDF generating thrust which is vertical to the outer wall of the building. Through the above process, the aerial vehicle may be stably attached to the outer wall of the building without effects according to internal and external parameters and as a result, the evacuated person may be safely boarded.

The aerial control unit 150 may detect a distance between the aerial body unit 110 and the outer wall of the building by using an ultrasonic sensor. The aerial control unit 150 determines that the aerial body unit 110 approaches the outer wall of the building when the detected distance is included in a predetermined range and may control an operation of the vacuum adsorption unit 140 according to the determined result. That is, the aerial control unit 150 may control the operation to attach the aerial body unit 110 to the outer wall of the building through vacuum adsorption by receiving vacuum pressure to the vacuum adsorption unit 140 from the vacuum pump, when it is determined that the aerial body unit 110 approaches the outer wall of the building.

In this case, the aerial control unit 150 may detect the building window frame by tracking an outline of the building window frame by using a camera when the aerial body unit 110 approaches the outer wall of the building. The aerial control unit 150 controls the operation of the main thrust unit 120 and the auxiliary thrust unit 130 to approach the aerial body unit 110 to the building window frame and then controls the operation of the vacuum adsorption unit 140 to attach the aerial body unit 110 to the outer wall of the building surrounding the building window frame.

That is, the aerial control unit 150 controls the operation of the main thrust unit 120 to fly the aerial body unit 110 in place in the air when the aerial body unit 110 reaches the corresponding altitude of the building, controls the operation of the auxiliary thrust unit 130 to approach the aerial body unit 110 to the outer wall of the building until a distance between the aerial body unit 110 and the outer wall of the building is included in a predetermined range, and then controls the operation of the vacuum adsorption unit 140 to attach the aerial body unit 110 to the outer wall of the building surrounding the building window frame.

The aerial control unit 150 may activate an approach mode when the aerial body unit 110 approaches the outer wall of the building. As the approach mode is activated, the aerial control unit 150 may reduce controllability according to a console input of the manager to prevent the aerial body unit 110 from being sensitively operated.

The aerial control unit 150 interrupts power supplied to the main thrust unit 120 and the auxiliary thrust unit 130 until the boarding of the evacuated person in the evacuating cage 111 is completed when the aerial body unit 110 is attached to the outer wall of the building through vacuum adsorption of the vacuum adsorption unit 140 to stop an operation of a motor which drives the propellers of the main thrust unit 120 and the auxiliary thrust unit 130.

The power supply unit 160 serves to supply the power to the main thrust unit 120 and the auxiliary thrust unit 130. The power supply unit 160 is connected with external constant power to supply the power to the main thrust unit 120 and the auxiliary thrust unit 130 and alternatively, implemented by a rechargeable battery to supply the power to the main thrust unit 120 and the auxiliary thrust unit 130 in the unmanned aerial vehicle itself.

The unmanned aerial vehicle 100 for evacuating people from the skyscraper according to the exemplary embodiment of the present disclosure may further include an altitude information database unit (not illustrated) which stores and databases altitude information for each layer with respect to a plurality of buildings. When information on the corresponding layer of the building for evacuating people is input, the aerial control unit 150 may control the operation of the main thrust unit 120 so that the unmanned aerial vehicle is automatically positioned on the corresponding layer of the building by searching the altitude information for the corresponding layer from the altitude information database.

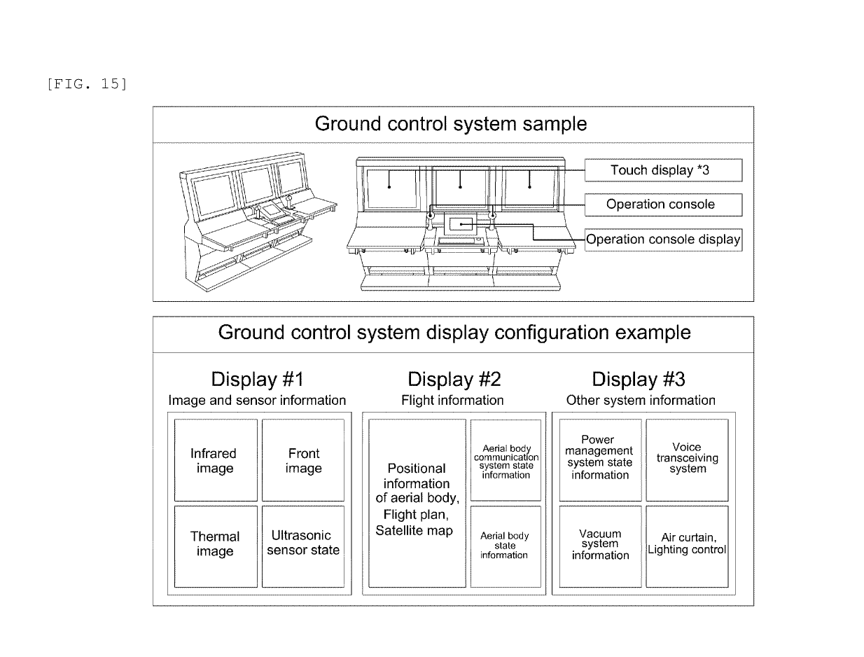

The unmanned aerial vehicle performs a given mission by receiving a command from the ground control system. The ground control system communicates with the unmanned aerial vehicle in real time for detecting the state of the unmanned aerial vehicle performing the mission and continuously displays the state to the manager. In the exemplary embodiment, the ground control system may be designed for the purpose of evacuating and the configuration is largely illustrated in FIG. 15.

As required conditions of the ground control system, largely, basic aerial information such as speed and altitude to power information and communication status information are included. Further, the ground control system may be designed to display states of various systems including the air curtain attached to the unmanned aerial vehicle, a thermal imaging camera, image information transmitted from the thermal imaging camera, the vacuum unit, and the like and control the states by the manager according to a situation.

FIG. 15 is an exemplary diagram illustrating an example of ground control system of controlling the unmanned aerial vehicle for evacuating people from the skyscraper according to the exemplary embodiment of the present disclosure. As illustrated in FIG. 15, the ground control system manages and monitors each system through three touch displays and the flight of the unmanned aerial vehicle uses and controls an operation console. Further, the ground control system may be constituted to issue orders for each system by using the operation console display. Each touch display shows information divided into image and sensor information, flight information, and other system information to the manager.

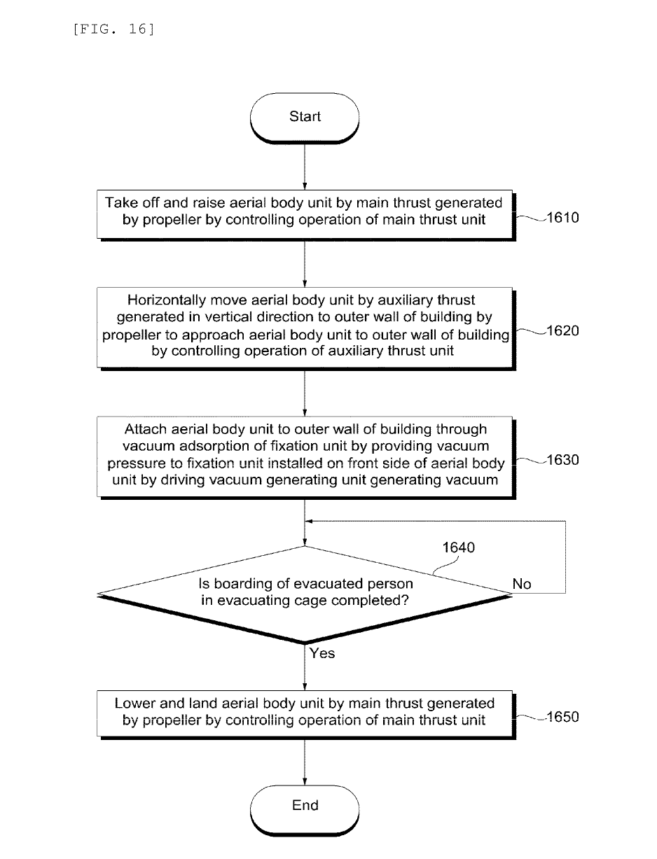

FIG. 16 is a flowchart illustrated for describing a managing method for the unmanned aerial vehicle for evacuating people from the skyscraper according to an exemplary embodiment of the present disclosure.

Referring to FIGS. 1 to 16, in step S1610, the unmanned aerial vehicle 100 for evacuating people from the skyscraper takes off and raises the aerial body unit 110 by main thrust generated by the propeller by controlling the operation of the main thrust unit 120 which is installed on two sides of the aerial body unit 110 and has a form in which the propeller is coupled in the cylindrical structure.

Next, in step S1620, the unmanned aerial vehicle 100 for evacuating people from the skyscraper horizontally moves the aerial body unit 110 by auxiliary thrust generated in a vertical direction to an outer wall of the building by the propeller to approach the aerial body unit to an outer wall of a building by controlling the operation of an auxiliary thrust unit 130 installed on a rear surface of the aerial body unit 110 and having the form in which the propeller is coupled in the cylindrical structure.

Next, in step S1630, the unmanned aerial vehicle 100 for evacuating people from the skyscraper attaches the aerial body unit 110 to the outer wall of the building through vacuum adsorption of the vacuum adsorption unit 140 by providing vacuum pressure to the vacuum adsorption unit 140 installed on a front surface of the aerial body unit 110.

Next, when the boarding of the evacuated person in the evacuating cage 111 provided in the aerial body unit 110 is completed (in a ‘yes’ direction of step S1640), in step S1650, the unmanned aerial vehicle 100 for evacuating people from the skyscraper takes on and lands the aerial body unit 110 by the main thrust generated by the propeller by controlling the operation of the main thrust unit 120. On the other hand, when the boarding of the evacuated person in the evacuating cage 111 is not completed (in a ‘no’ direction of step S1640), the unmanned aerial vehicle 100 for evacuating people from the skyscraper waits until the boarding of the evacuated person in the evacuating cage 111 is completed while stopping the operations of the main thrust unit 120 and the auxiliary thrust unit 130.

The exemplary embodiments of the present disclosure include a computer readable medium including a program command for executing operations implemented by various computers. The computer readable medium may include one or a combination of a program command, a local data file, and a data structure. The medium may be specially designed and configured for the present disclosure, or may be publicly known to and used by those skilled in the computer software field. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, an eMMC, specially formed to store and execute a program command. An example of the program command includes a high-level language code executable by a computer by using an interpreter, and the like, as well as a machine language code created by a compiler.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto.

Therefore, it should be understood that the above-described exemplary embodiments are illustrative in all aspects and do not limit the present disclosure. Therefore, it should be understood that the above-described exemplary embodiments are illustrative in all aspects and do not limit the present disclosure.

What is claimed is:

1. An unmanned aerial vehicle for evacuating people from a skyscraper, the unmanned aerial vehicle comprising:
an aerial body unit including an evacuating cage in which a boarding space for evacuating people is formed;
a main thrust unit having a form in which a propeller is coupled in a cylindrical structure and installed on both sides of the aerial body unit to take off and raise the aerial body unit by main thrust generated by the propeller;
an auxiliary thrust unit having the form in which the propeller is coupled in the cylindrical structure and installed on a rear surface of the aerial body unit and horizontally moving the aerial body unit by auxiliary thrust generated in a vertical direction to an outer wall of the building by the propeller to approach the aerial body unit to the outer wall of the building; and
a vacuum adsorption unit installed on a front surface of the aerial body unit and detachably fixed to the outer wall of the building through vacuum adsorption.

2. The unmanned aerial vehicle according to claim 1, wherein the main thrust unit is constituted by at least a pair on two sides of the aerial body unit, in which each pair of propellers rotates clockwise and counterclockwise and controls freedom degrees of the aerial body unit by a rotation operation for each pair of propellers.

3. The unmanned aerial vehicle according to claim 1, further comprising:
an aerial control unit detecting a distance between the aerial body unit and the outer wall of the building by using an ultrasonic sensor, determining that the aerial body unit approaches the outer wall of the building when the detected distance is included in a predetermined range, and controlling an operation of the vacuum adsorption unit according to the determined result.

4. The unmanned aerial vehicle according to claim 3, wherein the aerial control unit detects the building window frame by tracking an outline of the building window frame by using a camera when the aerial body unit approaches the outer wall of the building and controls the operation of the main thrust unit and the auxiliary thrust unit to approach the aerial body unit to the building window frame and then controls the operation of the vacuum adsorption unit to attach the aerial body unit to the outer wall of the building surrounding the building window frame.

5. The unmanned aerial vehicle according to claim 3, wherein the aerial control unit controls the operation of the main thrust unit to fly the aerial body unit in place in the air when the aerial body unit reaches the corresponding altitude of the building, controls the operation of the auxiliary thrust unit to approach the aerial body unit to the outer wall of the building until a distance between the aerial body unit and the outer wall of the building is included in a predetermined range.

6. The unmanned aerial vehicle according to claim 4, wherein the main thrust unit allows each pair of propellers rotating clockwise and counterclockwise to produce the same output and the sum of yaw becomes 0 and maintains a balance of the aerial body unit to fly the aerial body unit in place in the air, according to the control of the aerial control unit.

7. The unmanned aerial vehicle according to claim 3, wherein the aerial control unit activates an approach mode when the aerial body unit approaches the outer wall of the building and reduces controllability according to a console input of the operator to prevent the aerial body unit from being sensitively operated.

8. The unmanned aerial vehicle according to claim 1, further comprising:
an altitude information database unit making into a database and storing altitude information for each layer with respect to a plurality of buildings; and
an aerial control unit controlling the operation of the main thrust unit so that the unmanned aerial vehicle is automatically positioned on the corresponding layer of the building by searching the altitude information for the corresponding layer from the altitude information database when information on the corresponding layer of the building for evacuating people is input.

9. The unmanned aerial vehicle according to claim 1, further comprising:
a power supply unit supplying power to the main thrust unit and the auxiliary thrust unit,
wherein the power supply unit includes a rechargeable battery.

10. The unmanned aerial vehicle according to claim 9, further comprising:
an aerial control unit interrupting the power supplied to the main thrust unit and the auxiliary thrust unit until the boarding of the evacuated people in the evacuating cage is completed when the aerial body unit is attached to the outer wall of the building through the vacuum adsorption of the vacuum adsorption unit to stop an operation of a motor which drives the propellers of the main thrust unit and the auxiliary thrust unit.

11. The unmanned aerial vehicle according to claim 1, wherein the aerial body unit further includes an air curtain installed in a boarding entrance of the evacuating cage, and an air curtain operator which operates the air curtain for safety of the evacuated person when the boarding of the evacuated person in the evacuating cage is completed.

12. The unmanned aerial vehicle according to claim 1, wherein the aerial body unit further includes folding stairs installed on a front side of the evacuating cage for easy boarding of evacuated people which board the evacuating cage.

13. A managing method of an unmanned aerial vehicle for evacuating people from a skyscraper, the managing method comprising:
taking off and raising an aerial body unit by main thrust generated by a propeller by controlling an operation of a main thrust unit installed on both sides of the aerial body unit and having a form in which a propeller is coupled in a cylindrical structure;
horizontally moving the aerial body unit by auxiliary thrust generated in a vertical direction to an outer wall of the building by the propeller to approach the aerial body unit to an outer wall of a building by controlling the operation of an auxiliary thrust unit installed on a rear surface of the aerial body unit and having the form in which the propeller is coupled in the cylindrical structure; and
attaching the aerial body unit to the outer wall of the building through vacuum adsorption of a vacuum adsorption unit by providing vacuum pressure to the vacuum adsorption unit installed on a front surface of the aerial body unit.

14. The managing method according to claim 13, further comprising:
after the taking off and raising the aerial body unit, controlling freedom degrees of the aerial body unit by performing a rotation operation for each pair of propellers of the main thrust unit constituted by at least a pair on two sides of the aerial body unit clockwise and counterclockwise.

15. The managing method according to claim 13, further comprising:
after the approaching of the aerial body unit to the outer wall of the building,
detecting a distance between the aerial body unit and the outer wall of the building by using an ultrasonic sensor; and
determining that the aerial body unit approaches the outer wall of the building when the detected distance is included in a predetermined range.

16. The managing method according to claim 13, wherein the approaching of the aerial body unit to the outer wall of the building includes
detecting the building window frame by tracking an outline of the building window frame by using a camera when the aerial body unit approaches the outer wall of the building, and
controlling the operation of the main thrust unit and the auxiliary thrust unit to approach the aerial body unit to the building window frame, and
the attaching of the aerial body unit to the outer wall of the building includes
controlling the operation of the vacuum adsorption unit to attach the aerial body unit to the outer wall of the building surrounding the building window frame.

17. The managing method according to claim 13, further comprising:
after the taking off and raising of the aerial body unit,
controlling the operation of the main thrust unit to fly the aerial body unit in place in the air when the aerial body unit reaches the corresponding altitude of the building, and
the attaching of the aerial body unit to the outer wall of the building includes
controlling the operation of the auxiliary thrust unit to approach the aerial body unit to the outer wall of the building until a distance between the aerial body unit and the outer wall of the building is included in a predetermined range.

18. The managing method according to claim 17, wherein the flying of the aerial body unit in place in the air includes
allowing, by the main thrust unit, each pair of propellers rotating clockwise and counterclockwise to produce the same output and the sum of yaw becomes 0 and maintains a balance of the aerial body unit to fly the aerial body unit in place in the air.

19. The managing method according to claim 13, wherein the approaching of the aerial body unit to the outer wall of the building includes
activating an approach mode when the aerial body unit approaches the outer wall of the building, and
reducing controllability according to a console input of the operator to prevent the aerial body unit from being sensitively operated.

20. The managing method according to claim 13, further comprising:
making altitude information for each layer into a database with respect to a plurality of buildings and storing the altitude information in an altitude information database unit; and
controlling the operation of the main thrust unit so that the unmanned aerial vehicle is automatically positioned on the corresponding layer of the building by searching the altitude information for the corresponding layer from the altitude information database when information on the corresponding layer of the building for evacuating people is input.

21. The managing method according to claim 13, further comprising:
interrupting the power supplied to the main thrust unit and the auxiliary thrust unit until the boarding of the evacuated people in the evacuating cage provided in the aerial body unit is completed when the aerial body unit is attached to the outer wall of the building through the vacuum adsorption of the vacuum adsorption unit to stop an operation of a motor which drives the propellers of the main thrust unit and the auxiliary thrust unit.

22. The managing method according to claim 21, further comprising:
after the stopping of the operation of the motor,
operating the air curtain installed in a boarding entrance of the evacuating cage for safety of the evacuated person when the boarding of the evacuated person in the evacuating cage is completed.
